(19) United States
(12) Patent Application Publication
(10) Pub. No.: US 2009/0245934 A1
(43) Pub. Date: Oct. 1, 2009

(54) BUSHING STRUCTURE FOR SHEATHING A SHAFT OF A TONER SUPPLY MEMBER

(76) Inventor: Chin-Lung Han, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 12/056,265

(22) Filed: Mar. 26, 2008

(51) Int. Cl. F16B 7/00

(52) U.S. Cl. 403/342

(57) ABSTRACT

A bushing structure includes a base. A first hole is formed on the base. The bushing structure includes a supply member bushing installed inside the first hole of the base. An opening is formed on the supply member bushing for sheathing a shaft of a supply member. At least one groove is formed on an inner wall neighboring to the opening of the supply member bushing.

### BACKGROUND OF THE INVENTION

1. Field of the Invention

The present invention relates to a bushing structure, and more particularly, to a bushing structure for sheathing a shaft of a toner supply member.

2. Description of the Prior Art

Electrophotographic systems are generally employed in image-forming devices, the operation of which involves several steps: charging, exposing, developing, transferring, fusing, cleaning, and erasing. The color photoelectric image forming devices utilize toners of different colors to form color images. For example, a four-color photoelectric image-forming device utilizes a yellow toner, a magenta toner, a cyan toner, and a black toner to form color images.

Please refer to FIG. 1. FIG. 1 is a lateral sectional view of a cartridge 10 in the prior art. The cartridge 10 can be installed inside a casing of an image-forming device, such as a laser printer. The cartridge 10 includes a housing 12 for covering inner components thereof and toners. An opening 14 is formed on the housing 12. The cartridge 10 further includes a developer roller 16 installed inside the opening 14 of the housing 12 and protruding from the opening 14 partly for developing the toners inside the housing 12 to a photoconductive component, such as a photoconductive drum or a photoconductive belt. The developer roller 16 can be composed of a roller mechanism, such as a metal tubular mechanism or a tubular mechanism made of elastic material. A surface of the developer roller 16 can be a coating surface or be processed by a sand blasting method. A containing chamber 18 is formed inside the housing 12 for containing toners. The cartridge 10 further includes a supply roller 20 installed inside the containing chamber 18 and contacting with the developer roller 16 for supplying toners to the developer roller 16. The supply roller 20 can be composed of a roller mechanism made of metal or plastic material. The cartridge 10 further includes a toner paddle mechanism 22 installed inside the containing chamber 18 for stirring and conveying the toners to the supply roller 20. Then the supply roller 20 supplies the toners to the developer roller 16 in a rotatable manner. A bushing sleeves the supply roller 20 to fix the supply roller 20 on the housing 12. However there are toners of small size jamming between a shaft of the supply roller 20 and the bushing resulting in incorrect running or jammed situation of the supply roller 20 so that quality of printing images reduces.

### SUMMARY OF THE INVENTION

It is therefore a primary objective of the invention to provide a bushing structure for sheathing a shaft of a toner supply member for solving the above-mentioned problem.

According to the claimed invention, a bushing structure for sheathing a shaft of a toner supply member is disclosed. The bushing structure includes a base whereon a first hole is formed, and a toner supply member bushing installed inside the first hole of the base. An opening is formed inside the toner supply member bushing for sheathing the shaft of the supply member, and at least one sunken part is formed on an inner wall of the opening of the toner supply member bushing.

According to the claimed invention, a toner supply member structure of a developing apparatus includes a toner supply member including a roller and a shaft connected to the roller, and a bushing structure for sheathing the toner supply member. The bushing structure includes a base whereon a first hole is formed, and a supply member bushing installed inside the first hole of the base. An opening is formed inside the toner supply member bushing for sheathing the shaft of the toner supply member, and at least one sunken part is formed on an inner wall of the opening of the supply member bushing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a lateral sectional view of a cartridge in the prior art.

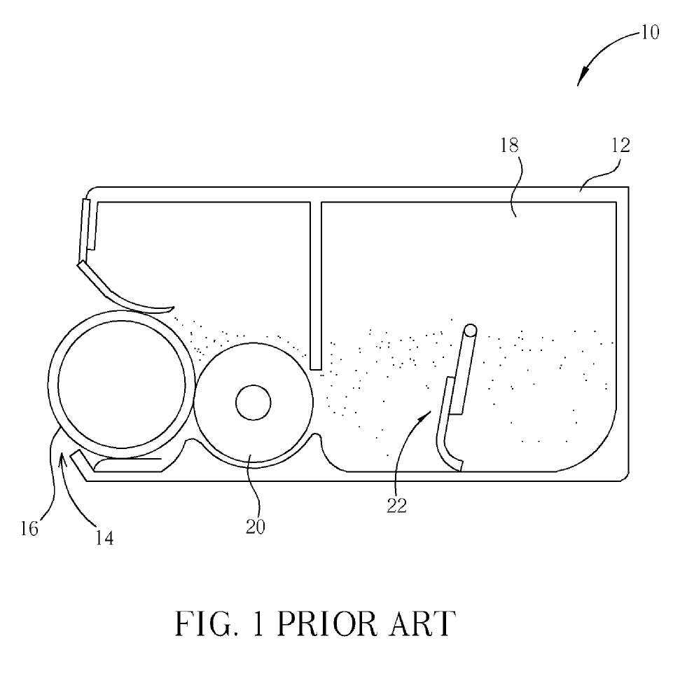

FIG. 2 is a schematic drawing of a developing apparatus according to a preferred embodiment of the present invention.

FIG. 3 is a top view of the developing apparatus according to the preferred embodiment of the present invention.

FIG. 4 is a sectional view of the developing apparatus along the line 4-4′ in FIG. 3 according to the preferred embodiment of the present invention.

FIG. 5 is a perspective drawing of the developing apparatus according to the preferred embodiment of the present invention.

FIG. 6 is a partial enlarged diagram of the developing apparatus according to the preferred embodiment of the present invention.

FIG. 7 is a diagram of a bushing structure according to the preferred embodiment of the present invention.

FIG. 8 is a schematic drawing of a supply member bushing according to the preferred embodiment of the present invention.

FIG. 9 is a front view of the supply member bushing according to the preferred embodiment of the present invention.

### DETAILED DESCRIPTION

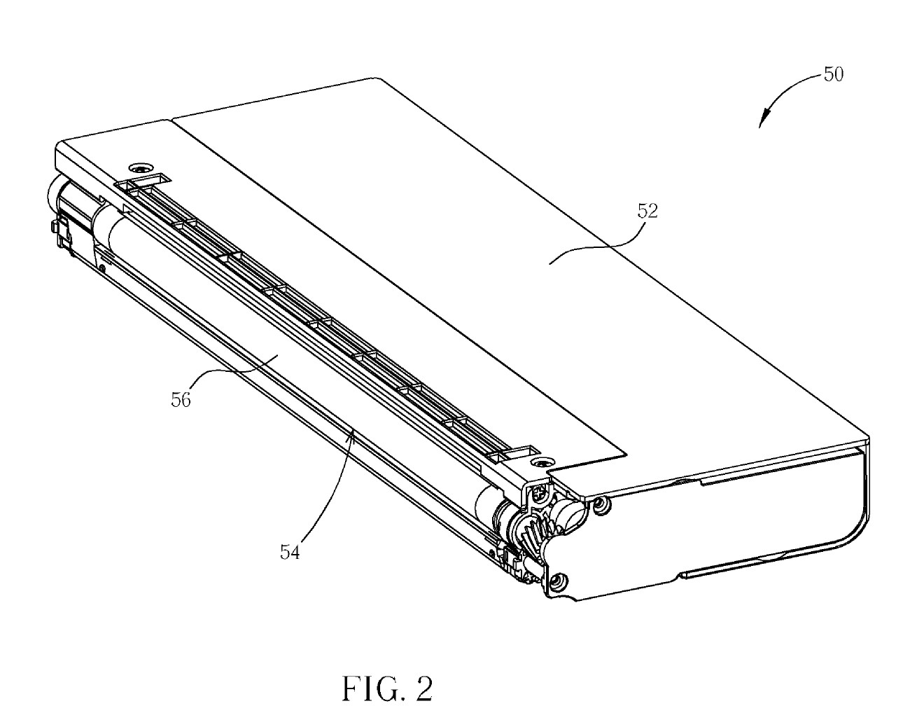

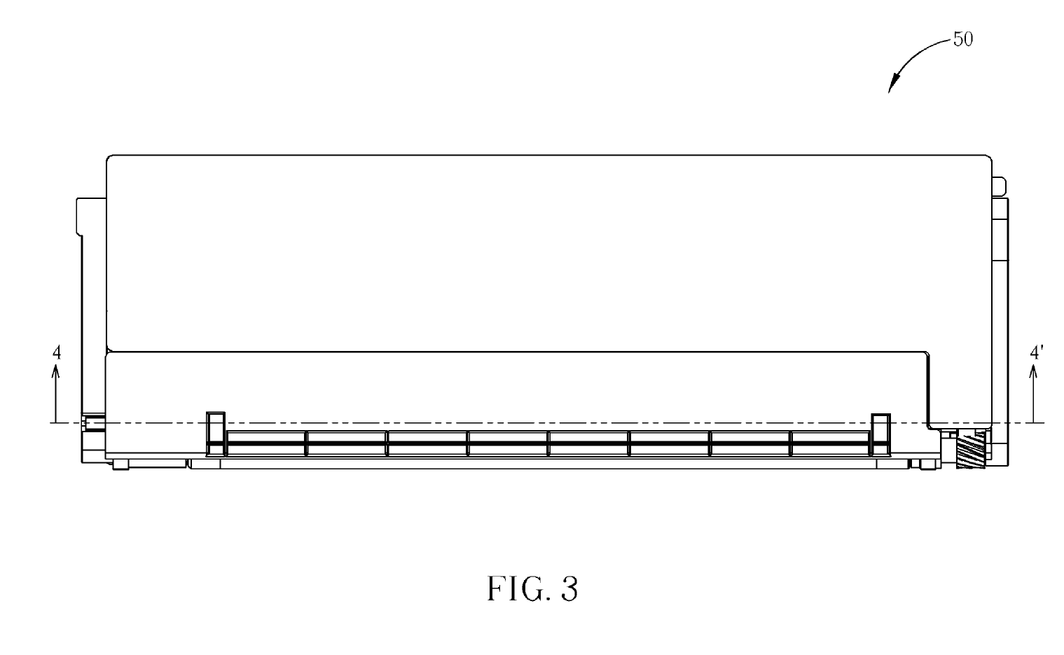

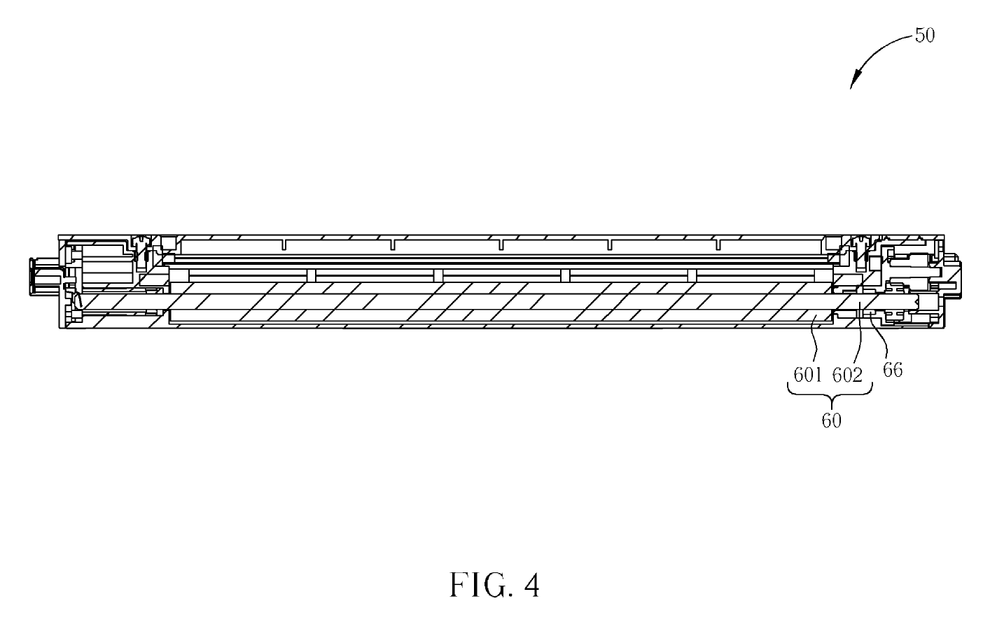

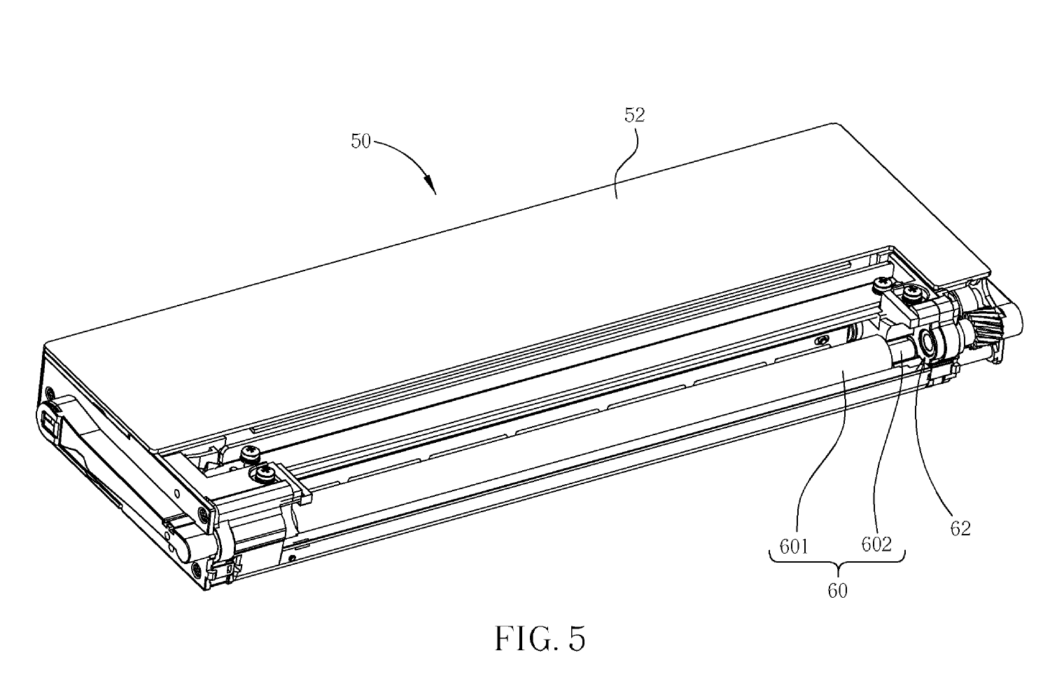

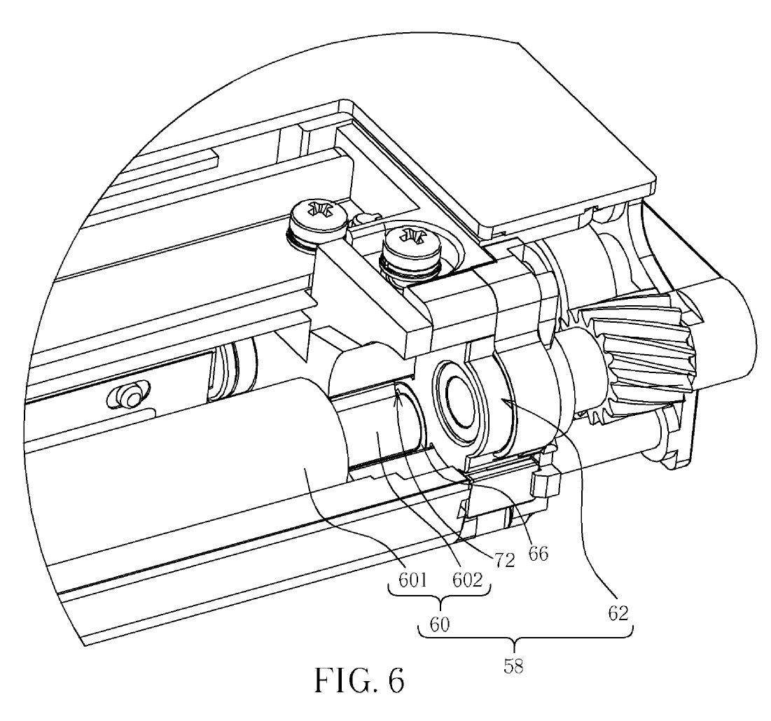

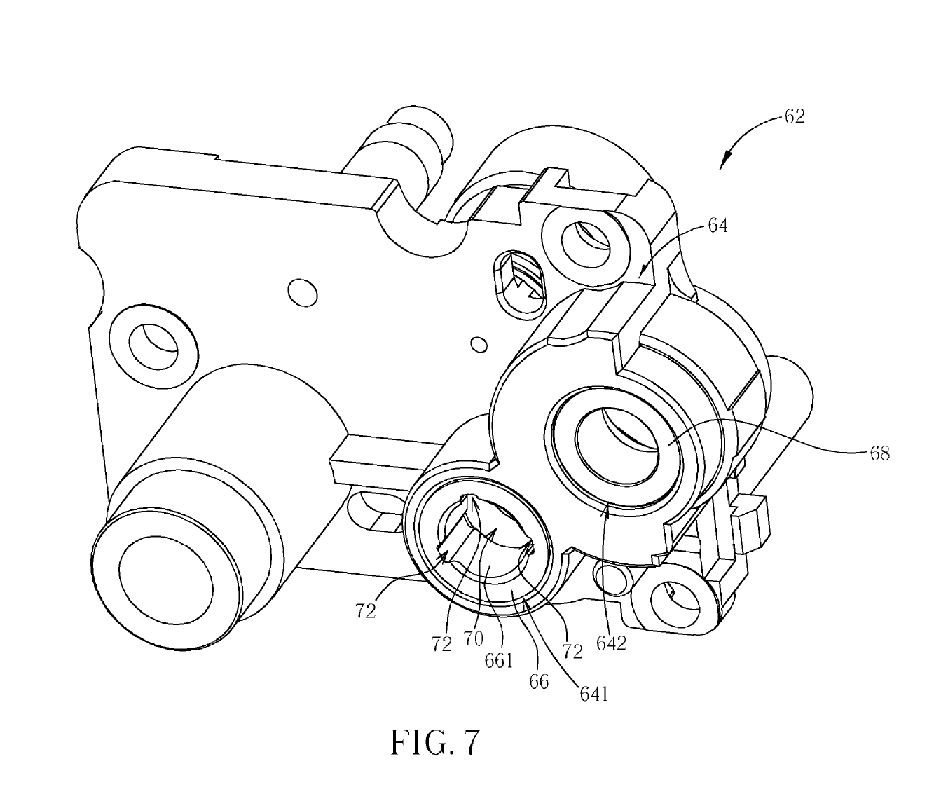

Please refer to FIG. 2 to FIG. 6. FIG. 2 is a schematic drawing of a developing apparatus 50 according to a preferred embodiment of the present invention. FIG. 3 is a top view of the developing apparatus 50 according to the preferred embodiment of the present invention. FIG. 4 is a sectional view of the developing apparatus 50 along the line 4-4′ in FIG. 3 according to the preferred embodiment of the present invention. FIG. 5 is a perspective drawing of the developing apparatus 50 according to the preferred embodiment of the present invention. FIG. 6 is a partial enlarged diagram of the developing apparatus 50 according to the preferred embodiment of the present invention. The developing apparatus 50, which can be a flat toner cartridge, can be installed inside a casing of an image-forming device, such as a laser printing device. The developing apparatus 50 includes a housing 52 for covering inner components and containing developer, such as toners. An opening 54 is formed on the housing 52. The developing apparatus 50 further includes a developer carrying member 56, which can be a developer roller, installed inside the opening 54 of the housing 52 and protruding from the opening 54 partly for developing the developer inside the housing 52 to a photoconductive component, such as a photoconductive drum or a photoconductive belt. The developer carrying member 56 can be composed of a roller mechanism, such as a hollow or solid metal tubular mechanism or a tubular mechanism made of elastic material, such as rubber material or plastic material. A surface of the developer carrying member 56 can be a coating surface or be processed by a sand blasting method. The developing apparatus 50 further includes a supply member structure 58 installed inside the housing 52 for supplying the developer to the developer carrying member 56. The supply member structure 58 includes a supply member 60 which can be a toner supply roller. The supply member 60 includes a roller 601 and a shaft 602 connected to the roller 601. The supply member structure 58 further includes a bushing structure 62 for sheathing the supply member 60. Please refer to FIG. 7. FIG. 7 is a diagram of the bushing structure 62 according to the preferred embodiment of the present invention. The bushing structure 62 includes a base 64 whereon a first hole 641 and a second hole 642 are formed. The bushing structure 62 further includes a supply member bushing 66 and a developer carrying member bushing 68. The supply member bushing 66 is installed inside the first hole 641 of the base 64. The supply member bushing 66 and the base 64 can be integrated. The developer carrying member bushing 68 is installed inside the second hole 642 of the base 64. The first hole 641 and the second hole 642 can be disposed on the same base 64 as shown in FIG. 7 or can be disposed on different bases respectively. The base 64 can be made of plastic or metal material.

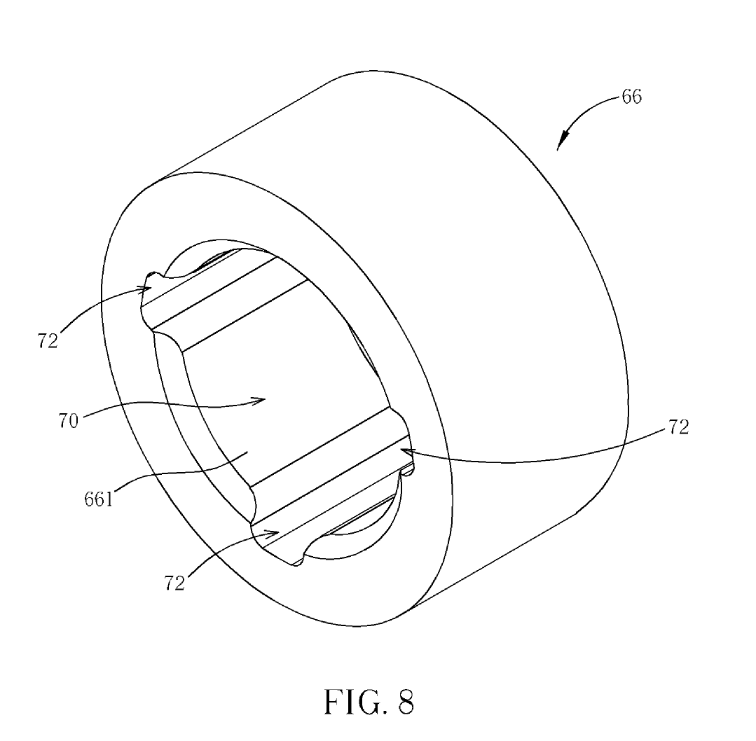

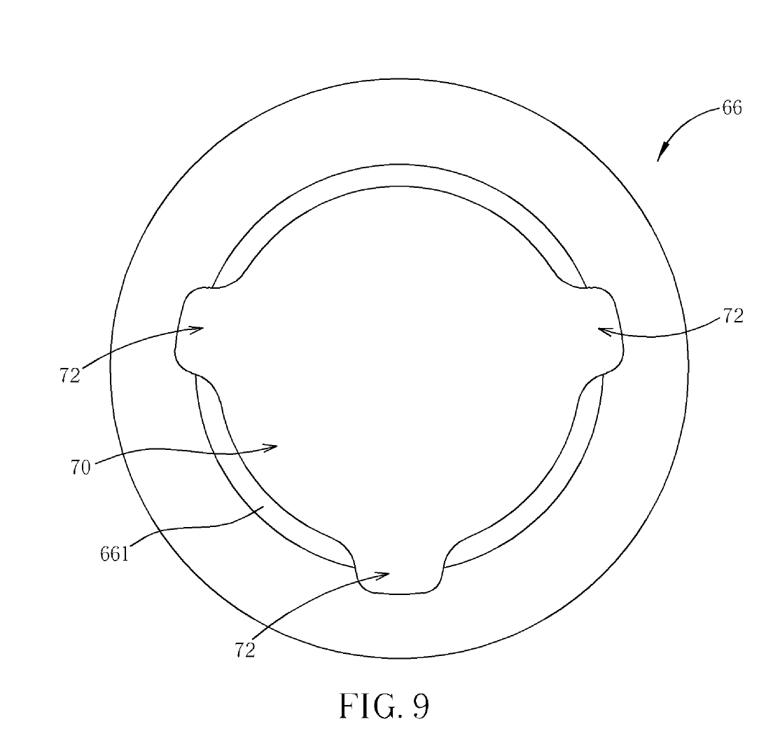

Please refer to FIG. 8 and FIG. 9. FIG. 8 is a schematic drawing of the supply member bushing 66 according to the preferred embodiment of the present invention. FIG. 9 is a front view of the supply member bushing 66 according to the preferred embodiment of the present invention. The supply member bushing 66 can be an annular bushing or of other shape. An opening 70 is formed inside the supply member bushing 66 for sheathing the shaft 602 of the supply member 60. The opening 70 can be an annular opening. At least one sunken part 72 is formed on an inner wall 661 neighboring to the opening 70 of the supply member bushing 66. The sunken part 72 can be a groove, such as a linear groove or a spiral groove. The sunken part 72 can be formed as an open groove from a front end to a bottom end of the opening 70 as shown in FIG. 7 or can be formed as a semi-open groove from the front end and to the middle of the opening 70. A plurality of the sunken parts 72 is formed on the inner wall 661 of the supply member bushing 66 in an annular arrangement as shown in FIG. 8, and the amount and disposition of the sunken parts 72 are not limited to the embodiment in FIG. 8. For example, the sunken parts 72 are disposed equidistantly or nonequidistantly. Developer, such as toners, of small size often jams between the shaft 602 of the supply member 60 and the supply member bushing 66, and at this time the developer can flow into the sunken parts 72 on the inner wall 661 of the supply member bushing 66 so as to prevent incorrect running or jammed situation of the supply member 60. The sunken parts 72 on the inner wall 661 of the supply member bushing 66 also can be for pressure effusion so as to unbalance external pressure on the shaft 602 of the supply member 60. It can discharge the developer jamming between the shaft 602 of the supply member 60 and the supply member bushing 66 so that the supply member 60 can run smoothly. The supply member bushing 66 can be made of plastic or metal material. The supply member bushing 66 and the base 64 can be integrated.

In contrast to the prior art, the sunken parts are formed on the inner wall of the supply member bushing so that the developer jamming between the shaft of the supply member and the supply member bushing can flow into the sunken parts for preventing incorrect running or jammed situation of the supply member. It can increase quality of printing images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bushing structure for sheathing a shaft of a supply member, the bushing structure comprising:
a base whereon a first hole is formed; and
a supply member bushing installed inside the first hole of the base, an opening being formed inside the supply member bushing for sheathing the shaft of the supply member, and at least one sunken part being formed on an inner wall of the opening of the supply member bushing.

2. The bushing structure of claim 1 wherein the sunken part is a groove.

3. The bushing structure of claim 2 wherein the sunken part is a linear groove.

4. The bushing structure of claim 2 wherein the sunken part is a spiral groove.

5. The bushing structure of claim 1 wherein the opening is an annular opening.

6. The bushing structure of claim 1 wherein a plurality of sunken parts is formed on the inner wall neighboring to the opening of the supply member bushing in an annular arrangement.

7. The bushing structure of claim 1 wherein the supply member bushing is an annular bushing.

8. The bushing structure of claim 1 wherein the supply member bushing and the base are integrated.

9. The bushing structure of claim 1 wherein the supply member bushing is made of plastic material.

10. The bushing structure of claim 1 wherein the supply member bushing is made of metal material.

11. The bushing structure of claim 1 wherein a second hole is formed on the base and the bushing structure further comprises a developer carrying member bushing installed inside the second hole of the base for sheathing a developer carrying member.

12. A supply member structure of a developing apparatus comprising:
a supply member comprising:
a roller; and
a shaft connected to the roller; and
a bushing structure for sheathing the supply member comprising:
a base whereon a first hole is formed; and
a supply member bushing installed inside the first hole of the base, an opening being formed inside the supply member bushing for sheathing the shaft of the supply member, and at least one sunken part being formed on an inner wall of the opening of the supply member bushing.

13. The supply member structure of claim 12 wherein the sunken part is a groove.

14. The supply member structure of claim 13 wherein the sunken part is a linear groove.

15. The supply member structure of claim 13 wherein the sunken part is a spiral groove.

16. The supply member structure of claim 12 wherein the opening is an annular opening.

17. The supply member structure of claim 12 wherein a plurality of sunken parts is formed on the inner wall of the opening of the supply member bushing in an annular arrangement.

18. The supply member structure of claim 12 wherein the supply member bushing and the base are integrated.

19. The supply member structure of claim 12 wherein the supply member bushing is made of plastic material.

20. The supply member structure of claim 12 wherein the supply member is a supply roller.
